(19) United States
(12) Patent Application Publication
(10) Pub. No.: US 2026/0071699 A1
(43) Pub. Date: Mar. 12, 2026

(54) MODULAR SYSTEM FOR SUPPORTING PIPES AND CABLES AND METHOD FOR INSTALLATION THEREOF

(71) Applicant: Bunch Welding Ltd., Rocky Mountain House (CA)

(72) Inventors: Darcy Roy Knopp, Leslieville (CA); Sako Vandermeer, Rocky Mountain House (CA)

(21) Appl. No.: 18/883,530

(22) Filed: Sep. 12, 2024

(51) Int. Cl. F16L 3/22; H02G 3/04

(52) U.S. Cl. CPC F16L 3/22; H02G 3/0456

(57) ABSTRACT

A system is provided for supporting pipes and cables at a processing facility. The system includes: an upper pipe support frame, fitable with one or more pipe sections; a lower pipe support frame, fitable with one or more pipe sections, said lower pipe support frame configured to be joined at an upper end thereof with the upper pipe support frame, once the one or more pipe sections are fitted to the upper pipe support frame and the lower pipe support frame; and a cable tray, connectable to one or more foundation posts at the processing facility and runnable with one or more cables. The joined upper and lower pipe support frames are fixable above the cable tray and cables such that a height of the lower pipe support frame above the cable tray provides a minimal clearance required for the cables. A method is further provided for assembling a support structure for supporting pipes and cables.

### FIELD

The present disclosure relate to a modular structure and system for supporting pipes and cables, and methods for installation of such support of structures.

### BACKGROUND

Pipe and cable support structures are used at processing facilities, where the pipes and the contents therein are directed to various processing equipment and vessels at the processing facility, and where power and control is also required for the equipment and vessels. One example of such processing site might be a up-stream, mid-stream, or down-stream oil or gas processing site.

Typically pipe and cable supports are arranged in a hierarchical manner, with heavier pipes, which carry fluids or gases, occupying a lower and upper section and cable trays, supporting lighter cables, positioned above the upper section. In this arrangement, the pipes are usually positioned at lower and upper levels depending on respective fluids and gravity flow requirements and accessibility for maintenance and operation. The racks of the support structure ensure stability and prevent sagging or deformation. Above the upper pipe support section, cable trays are commonly installed to support electrical, communication, and instrumentation cables.

However, the afore-mentioned structural arrangement of conventional pipe and cable support structures pose various challenges.

Conventional pipe structures often require significant height clearance above the pipes of each of the upper and lower support structure sections. Pipe typically requires at least 5 feet of clearance above to allow for branched connections to rise sufficient elevation to clear the header piping and make a direction change towards a connecting piece of pipe or equipment. This necessity for vertical space limits the flexibility of the design and construction process. The need for ample height clearance of the pipe support sections raises the placement of the cable trays, forcing them to be installed at higher elevations, leading to inefficient use of space.

The increased height of traditional pipe structures can pose a stability issue, especially in terms of wind loads and the center of gravity. As these structures grow taller, they become more susceptible to lateral forces from things like seismic events, wind, thermal expansion and contraction, or sudden starts or stops of fluid flow, known generally as susceptible lateral force conditions, which can induce sway or instability.

Additionally, the higher center of gravity resulting from increased height raises concerns about the overall structural stability, especially in susceptible lateral force conditions. To address these stability concerns, traditional structures often require the use of stiffening, thickening, or higher-grade steel materials in their construction to provide resilience against external forces and also may require additional members to provide stability. However, each of these methods increase construction costs and may introduce challenges related to transportation, fabrication, and installation.

Additionally, in structures where pipes and cable trays are installed at elevated levels, construction and maintenance personnel may face challenges related to working at heights. Accessing these elevated components requires specialized equipment and safety precautions, increasing the complexity and cost of construction and maintenance operations.

Also, placing cable trays above pipes can lead to inefficient use of space within the structure. The vertical space above the pipes remains under-utilized.

The conventional process typically involves using cranes or other heavy equipment to lift and position the pipes into place. Once the pipes are installed, another round of installation is necessary for installation of the cable trays and then running the cables along the cable trays. Alternatively, cable trays can be installed first and then pipe are installed from a side of each pipe support afterwards. These sequential installation approaches not only extends the overall project timeline but also increases labor costs and resource utilization. Additionally, coordinating the schedules of crane operators and installation crews adds logistical challenges, potentially causing delays and disruptions to the construction timeline.

U.S. Pat. No. 6,644,601 teaches a cable tray stand for supporting a cable tray. The cable tray stand has a height adjustable first member, a support member attached to an upper end of the first member, and a base attached to a lower end of the first member. The support member is adapted to support the cable tray such that the cable tray is supported at a second vertical position above a first vertical position at which the base is located, and the first member is collapsible to a transport height. While this reference does teach multiple levels and adjustability for the purposes of access and cable running, there is no teaching of pipe supports.

U.S. Pat. No. 11,557,887 is related to a cable laying device for transporting and laying a cable and comprises: a base section and an extension section with adjustable length, wherein the extension section and the base section are connected to each other and are moveable relative to each other, both adapted to include one elongated cable carrier having a cable carrying portion. The carrying portion enables the cables to move along with the cable carriers and the height of the base section and/or the extension section can be adjusted. However, this reference does not teach pipe supports.

CN103292040A relates a height adjustable oil pipe support comprising bases, stand columns and a support beam. The stand columns are vertically arranged above the bases and connected with the support beam above thereof. The height-adjustable oil pipe support has the advantages that grooves on the stand columns can be inserted with steel columns in different places, so that combined with steel columns, the oil pipe support is height-adjustable, resistant to breakage due to load bearing, convenient to mount, simple in structure. However, this is not a pipe and cable support structure and there is not teaching of cable supports.

KR20180073114 teaches a holding fixture for a double-floor earthquake resistant structure, the holding fixture including an electrical wiring tray, to improve durability and reduces overall work process required for separate installation of conventional wire trays. The electric wiring tray includes: a support plate, a rod body extending upward from the support plate, and a stringer coupling portion coupled to an upper portion of the rod body. A holding fixture includes a support to be fitted to an outer surface of the rod. However, this reference is not related to pipe supports.

A need therefore exists for pipe and cable support structures that address shortfalls of the conventional designs.

### SUMMARY

A system is provided for supporting pipes and cables at a processing facility. The system includes: an upper pipe support frame, fitable with one or more pipe sections at a fabrication site; a lower pipe support frame, fitable with one or more pipe sections at the fabrication site, said lower pipe support frame configured to be joined at an upper end thereof with the upper pipe support frame at the fabrication site, once the one or more pipe sections are fitted to the upper pipe support frame and the lower pipe support frame; and a cable tray, connectable to one or more foundation posts at the processing facility and runnable with one or more cables. The joined upper and lower pipe support frames are fixable above the cable tray and cables at the processing facility such that a height of the lower pipe support frame above the cable tray provides a minimal clearance required for the cables.

A method is further provided for assembling a support structure and system for supporting pipes and cables. The method includes the steps of: at a fabrication site, fitting an upper pipe support frame and a lower pipe support frame with one or more pipe sections; at the fabrication site, raising the upper pipe support frame onto said lower pipe support frame and joining the upper pipe support frame to an upper end of the lower pipe support frame; at a processing facility, connecting a cable tray to one or more foundation posts; at the processing facility, running cables along a cable tray; and at the processing facility, fixing the joined upper and lower pipe support frames above the cable tray. The steps taking place at the fabrication site occur simultaneously as the steps of connecting the cable tray and running cables at the processing facility.

It is to be understood that other aspects of the present disclosure will become readily apparent to those skilled in the art from the following detailed description, wherein various embodiments of the disclosure are shown and described by way of illustration. As will be realized, the disclosure is capable of other and different embodiments and its several details are capable of modification in various other respects, all without departing from the spirit and scope of the present disclosure. Accordingly, the drawings and detailed description are to be regarded as illustrative in nature and not as restrictive.

### BRIEF DESCRIPTION OF THE DRAWINGS

A further, detailed, description of the disclosure, briefly described above, will follow by reference to the following drawings of specific embodiments of the disclosure. The drawings depict only typical embodiments of the disclosure and are therefore not to be considered limiting of its scope. In the drawings:

FIG. 1 is a perspective view of a cable tray of the present support structure, being run with cables;

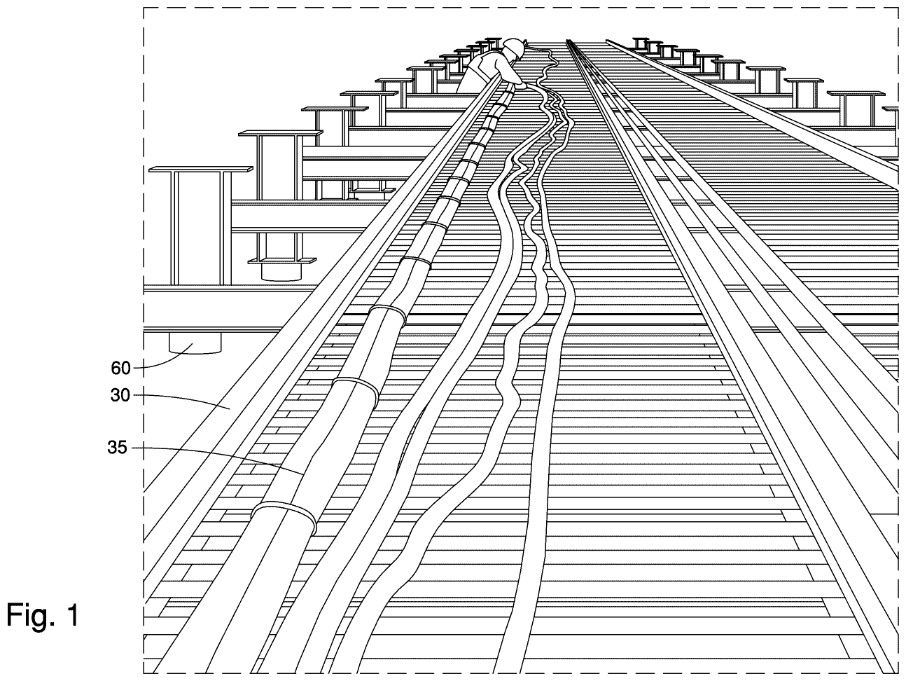

FIG. 2 is a perspective view of lower and upper pipe support frames of the present support structure with pipe sections supported thereon;

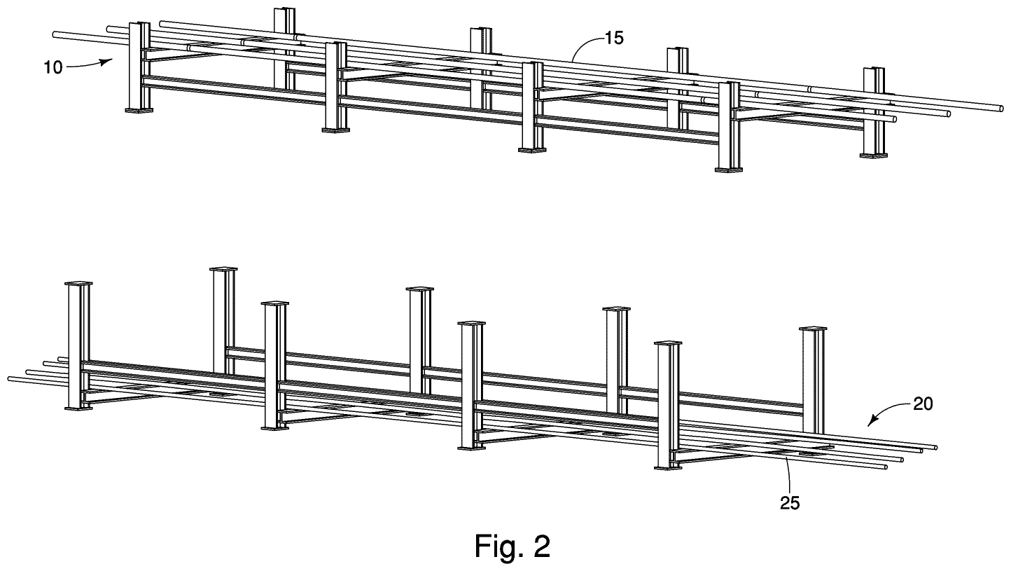

FIG. 3 illustrates a step of the present method in which an upper pipe support frame is raised onto a lower pipe support frame;

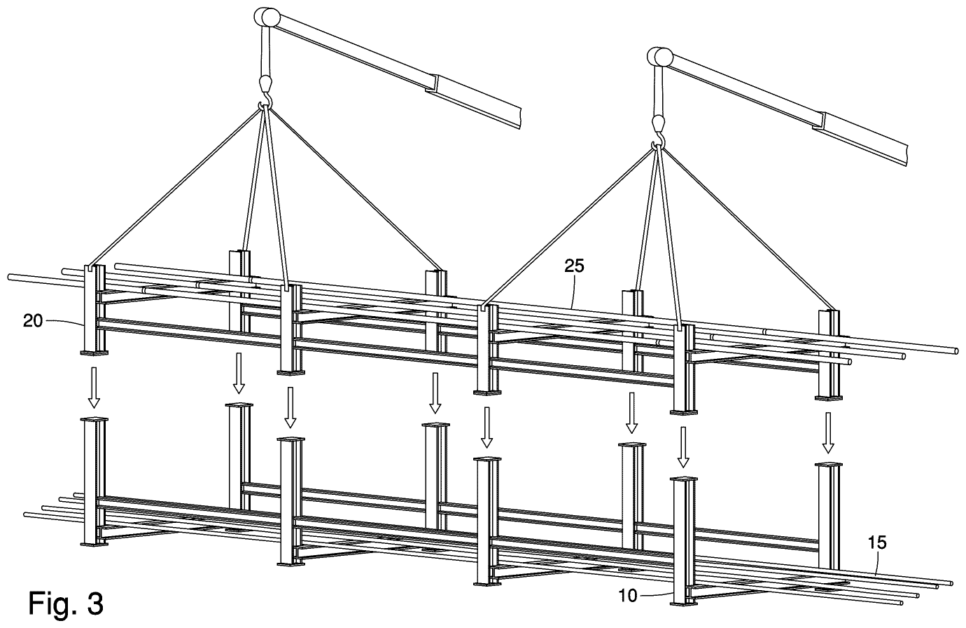

FIG. 4 is a perspective view of the upper and lower pipe support frames being fitted to one another; and

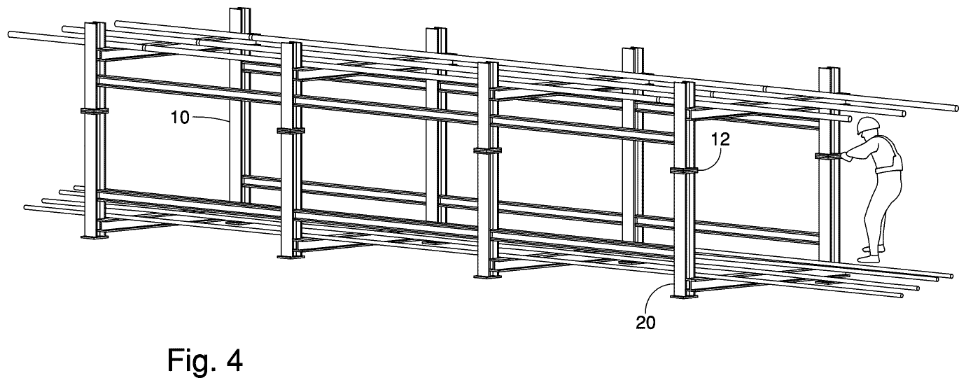

FIG. 5 is a perspective view of one embodiment of the of an assembled support structure and system of the present disclosure, showing an optional staircase fitted to the structure.

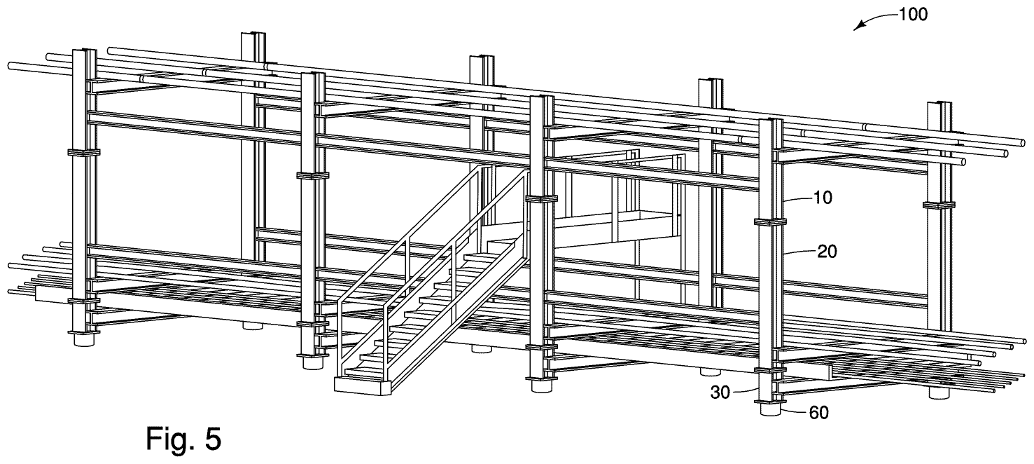

The drawings are not necessarily to scale and in some instances, proportions may have been exaggerated in order to more clearly depict certain features.

### DETAILED DESCRIPTION

The description that follows and the embodiments described therein are provided by way of illustration of an example, or examples, of particular embodiments of the principles of various aspects of the present disclosure. These examples are provided for the purposes of explanation, and not of limitation, of those principles and of the disclosure in its various aspects.

The present disclosure presents a modular support structure for supporting pipes and cables, commonly at processing facilities that can include mid-stream processing facilities, although it would be well understood that the present support structure could be used in various applications. The present support structure enhances modularity and resolves issues associated with the clearance required around pipes supported by the structure.

Specifically, in the present support structure, the cable trays are located below a lower pipe support frame, to optimize space utilization and facilitate easier installation and maintenance of both pipes and cables and to lower the overall height of the support structure and its center of gravity. This has significant implications in reducing the amount of steel required since a lower center of gravity leads to lower stability requirements, lower amount of steel required. Overall, the pipe and cable support structure system addresses challenges in the setup of such structures and subsequent running of pipes and cables in such structures.

With reference to the Figs., the present modular pipe and cable support structure system 100 includes a plurality of support segments 50, some configured to be assembled at a fabrication site, and shipped to a processing facility for installation, and others to be installed directly at the processing facility. Each support segment 50 comprises:
a. an upper pipe support frame 10,
b. a lower pipe support frame 20, and
c. one or more cable trays 30.

A method for assembling the modular support structure system 100 is done in multiple steps at both the fabrication site and the processing facility:

Assembly at the fabrication site: The upper and lower pipe support frames 10, 20 are each assembled and fitable with the pipe sections 15, 25 that will be required at the processing facility. Since each of the upper and lower support frames 10, 20 are on the ground, they can be accessed by workers standing on the ground without the need for areal work platforms (AWP) and scaffolds etc., and associated worker fall arrest systems commonly required for fitting of the pipe sections 15, 25. Once both upper and lower support frames 10, 20 are fitted with pipe sections 15, 25, the upper support frame 10 is raised onto the lower support frame 20 and the two are affixed to one another. The connection points between the lower and upper support frames 10, 20 are at a height that is accessible by workers standing on the ground or standing on a short ladder without the need for areal work platforms (AWP) and scaffolds, while still providing the required clearance above the lower pipe sections 10. Once connected, the joined upper and lower support frames 10, 20 with pipe sections 15, 25 supported thereon, can be transported to the processing site for installation.

Installation at the processing site: The cable trays 30 of the present system 100 can be installed and the cables 35 can be run at the processing site simultaneously while upper and lower support frames 10, 20 are being assembled at the fabrication site. This saves significant time in the overall installation and running process. The cable trays 30 are connectable to one or more foundation posts 60 that are already and commonly installed at the processing site, along the path to be taken by the pipes and cables. Once the cable trays 30 are affixed to the foundation posts 60, cables 35 can be run along the trays 30 and positioned for connection with equipment and vessels at the processing site.

When the joined upper and lower support frame structure 10, 20 arrives at the processing site, the cable trays 30 are already installed and the cables 35 already run. The joint upper and lower support frame 10, 20, with pipe sections 15, 25 supported thereon are then connected above the cable tray 30 and the pipe sections are connected to one another.

Pipe requires additional clearance above it, but the cable tray requires much less clearance above it. In traditional systems with the cable tray above the pipe supports, the overall structure height can be as much as the height of each support plus twice the pipe clearance height. By contrast, in the present support structure 100, the height of each support plus only one times the pipe clearance and one times the cable tray clearance is all that's required. Because cable tray clearance is significantly less than pipe clearance the overall structure height is reduced.

Pipe height clearance for the lower pipe support is only required in certain places where pipe interconnects are being made into buildings. At places where the clearance is not required, for example, between buildings, walkovers can be placed to allow passage from one side of the support structure 100 to the other or to enter side doors of buildings.

Since minimal height clearance is needed above the cables 35 of the cable tray 30, the lower support frame 20 with lower pipe sections 25 run thereon can be installed low and very close above the cable trays 30. The clearance needed above the lower pipe sections 25 is built into the design of the spacing of the upper and lower support frames 10, 20 and clearance for the upper pipe sections 15 is completely unhindered since there is no longer a cable tray above it. By installing the cable trays 30 at the processing site while the pipe support frames 10, 20 are being assembled at the fabrication site, construction time and onsite labor are minimized.

Moreover, placing the cable trays 30 in the lower portion of the overall support structure 100 maximizes the utilization of space that would otherwise be underutilized. With cable trays 30 located at lower positions, maintenance personnel no longer need to work at elevated heights to run the cables 35 along the cable trays 30. Similarly, running of pipe sections 15, 25 along the upper and lower support frames 10, 20 can also be done at ground level. This eliminates the need for personnel to use ladders, scaffolding, or other elevated platforms, reducing the risk of accidents and injuries associated with working at heights. By working at ground level, technicians can perform their tasks more safely and efficiently, minimizing downtime and improving overall productivity.

As well, since the final assembled support structure 100 has a lower overall height than traditional structures, it is more stable and less likely to sway, tilt or collapse or crumple in the wind. The more stable, shorter structure system 100 also allows for the present support structure system 100 to be made from standard materials, with no need for extra high-grade steels, as is often required for the higher traditional structures.

The present support structure 100 and method of assembly serves to speed up the construction sequence of events. Unlike the historical pipe support structures in which the cable tray is assembled following all of the pipe installation, in the present system 100, the cable tray 30 is a separate module separately installed and run with cables 35. This allows the cable tray 30 to be set up and for the electricians to pull cable 35 on the processing facility site prior to any pipe support frames 10, 20 being assembled. This allows for different trades to construct simultaneously rather than consecutively. Then while the upper and lower pipe support frames 10, 20 are being installed above the cable trays 30, the electricians can work on other duties of providing power to the processing facility. This method can reduce up to 25% of construction schedule at the processing facility.

The previous description of the disclosed embodiments is provided to enable any person skilled in the art to make or use the present disclosure. Various modifications to those embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A system for supporting pipes and cables at a processing facility, said system comprising:
a. an upper pipe support frame, fitable with one or more pipe sections at a fabrication site;
b. a lower pipe support frame, fitable with one or more pipe sections at the fabrication site, said lower pipe support frame configured to be joined at an upper end thereof with a lower end of the upper pipe support frame at the fabrication site, once the one or more pipe sections are fitted to the upper pipe support frame and the lower pipe support frame; and
c. a cable tray, connectable to one or more foundation posts at the processing facility and runnable with one or more cables,
wherein the joined upper and lower pipe support frames are fixable above the cable tray and cables at the processing facility such that a height of the lower pipe support frame above the cable tray provides a minimal clearance required for the cables.

2. The system of claim 1, wherein the upper end of the lower pipe support frame is at a height accessible by workers standing on the ground.

3. The system of claim 2, wherein a height of the lower pipe support frame is sized to provide a predetermined clearance above the lower pipe sections.

4. The system of claim 2, further comprising one or more walkovers positioned over the lower pipe support frame to allow passage from one side of the support structure to another.

5. The system of claim 4, wherein the lower support frame are fixed above the cable tray at a minimal predetermined height clearance.

6. The system of claim 5, cable trays 30 located at lower positions, maintenance personnel no longer need to work at elevated heights to run the cables 35 along the cable trays 30. Similarly, running of pipe sections 15, 25 along the upper and lower support frames 10, 20 can also be done at ground level.

7. A method of assembling a support structure and system for supporting pipes and cables, the method comprising the steps of:
d. at a fabrication site, fitting an upper pipe support frame and a lower pipe support frame with one or more pipe sections;
e. at the fabrication site, raising the upper pipe support frame onto said lower pipe support frame and joining the upper pipe support frame to an upper end of the lower pipe support frame;
f. at a processing facility, connecting a cable tray to one or more foundation posts;
g. at the processing facility, running cables along the cable tray; and
h. at the processing facility, fixing the joined upper and lower pipe support frames above the cable tray,
wherein the steps taking place at the fabrication site occur simultaneously as the steps of connecting the cable tray and running cables at the processing facility.

8. The method of claim 7, wherein the step of fitting the upper pipe support frame and the lower pipe support frame with one or more pipe sections comprises loading the pipe sections onto the pipe support frames in the absence of a need for areal work platforms (AWP), ladders or scaffolds.

9. The method of claim 8, wherein the step of joining the upper pipe support frame to an upper end of the lower pipe support frame is conducted at a height accessible by workers without a need for areal work platforms (AWP) or scaffolds.

10. The method of claim 9, wherein the steps of connecting a cable tray to the one or more foundation posts and running the cables along the cable tray at the processing facility are conducted simultaneously while the upper support frame and lower support frame are being fitted with one or more pipe sections at the fabrication site.

11. The method of claim 10, further comprising the step of connecting the pipe sections to one another.
